(19) United States
(12) Patent Application Publication
(10) Pub. No.: US 2016/0275227 A1
(43) Pub. Date: Sep. 22, 2016

(54) OPTIMIZING INTERCONNECT DESIGNS IN LOW-POWER INTEGRATED CIRCUITS (ICs)

(71) Applicant: QUALCOMM Incorporated, San Diego, CA (US)

(72) Inventors: Chunchen Liu, San Diego, CA (US); Ju-Yi Lu, Tainan City (TW); Shengqiong Xie, San Diego, CA (US)

(21) Appl. No.: 14/658,504

(22) Filed: Mar. 16, 2015

(51) Int. Cl. G06F 17/50

(52) U.S. Cl. CPC G06F 17/5072; G06F 17/5081

(57) ABSTRACT

Aspects disclosed in the detailed description include optimizing interconnect designs in low-power integrated circuits (ICs). In this regard, in one aspect, functional blocks having substantially correlated power utilization patterns are grouped into a power-related cluster to share a sleeping cell, thus leading to a reduced number of sleep transistors and a simplified interconnect design in a low-power IC. In another aspect, functional blocks having higher block temperatures are separated into more than one power-related cluster, improving heat dissipation in the low-power IC. A simulated annealing (SA) process is employed to determine an optimized placement for the low-power IC based on a power-related cost function that includes a power-related parameter and a heat-related parameter. By running the SA process based on the power-related cost function, it is possible to determine the optimized placement that leads to the reduced number of sleep transistors and improved heat dissipation in the low-power IC.

### BACKGROUND

I. Field of the Disclosure

The technology of the disclosure relates generally to designing integrated circuits (ICs).

II. Background

Mobile communication devices have become increasingly common in current society. The prevalence of these mobile communication devices is driven in part by the many functions that are now enabled on such devices. Demand for such functions increases the processing capability requirements for the mobile communication devices. As a result, mobile communication devices have evolved from being purely communication tools into sophisticated mobile entertainment centers.

Concurrent with the rise in the processing capabilities of mobile communication devices is the increase in power consumption by the mobile communication devices. Low-power operations are commonly employed by the mobile communication devices to conserve power and prolong battery life. One aspect of the low-power operations involves reducing leakage power consumption by opportunistically switching off functional blocks that are idle or on standby. Sleep transistors, such as metal-oxide semiconductor field-effect transistors (MOSFETs), are commonly employed in the mobile communication devices to switch off the functional blocks for the benefit of reduced leakage power consumption.

While the use of sleep transistors may help reduce leakage power consumption of the functional blocks, sleep transistors are not a panacea. In fact, the sleep transistors may cause leakage power consumption as well. In addition, the sleep transistors may consume space within an integrated circuit (IC). Given current miniaturization trends in the industry, the use of space in this manner may be commercially unacceptable. Finally, each sleep transistor is an additional component and may increase the build of material (BoM) cost of the IC.

### SUMMARY OF THE DISCLOSURE

Aspects disclosed in the detailed description include optimizing interconnect designs in low-power integrated circuits (ICs). In this regard, in one aspect, functional blocks having substantially correlated power utilization patterns are grouped into a power-related cluster to share a sleeping cell, thus leading to a reduced number of sleep transistors and a simplified interconnect design in a low-power IC. In another aspect, functional blocks having higher block temperatures are separated into more than one power-related cluster to improve heat dissipation in the low-power IC. A simulated annealing (SA) process is employed to determine an optimized placement for the low-power IC. The SA process utilizes a power-related cost function that includes a power-related parameter and a heat-related parameter, among other parameters, to group the substantially power-correlated functional blocks and to separate the high-temperature functional blocks. By running the SA process based on the power-related cost function, it is possible to determine the optimized placement that leads to the reduced number of sleep transistors and improved heat dissipation in the low-power IC.

In this regard, in one aspect, a method for designing an optimized interconnect design in a low-power IC is provided. The method comprises determining, using software on a computing device, one or more power correlations for a plurality of functional blocks in a low-power IC. The method also comprises grouping the plurality of functional blocks into one or more power-related clusters based on the one or more power correlations for the plurality of functional blocks. The method also comprises generating, using the software on the computing device, an optimized placement for the one or more power-related clusters based on a power-related cost function. The method also comprises determining an interconnect design for the one or more power-related clusters based on the optimized placement. The method also comprises outputting a finalized interconnect design through an output device associated with the computing device.

In another aspect, a method for optimizing interconnect design in a low-power IC is provided. The method comprises determining a power correlation for each pair of functional blocks in a low-power IC. The method also comprises generating an optimized placement comprising one or more power-related clusters by running an SA process using a computing device. The SA process is based on a power-related cost function and the power correlation of each pair of functional blocks. The SA process stops when reaching a local minimum cost relative to the power-related cost function or reaching a predetermined maximum number of iterations. The method also comprises determining an interconnect design for the one or more power-related clusters based on the optimized placement. The interconnect design includes sharing a sleep transistor between the one or more power-related clusters having positive power correlations. The interconnect design also comprises sharing a sleep switch between the one or more power-related clusters having negative power correlations. The method also comprises outputting a finalized interconnect design through an output device associated with the computing device.

In another aspect, a non-transitory computer readable medium comprising software with instructions is provided. The instructions determine one or more power correlations for a plurality of functional blocks in a low-power IC. The instructions also group the plurality of functional blocks into one or more power-related clusters based on the one or more power correlations. The instructions also generate an optimized placement for the one or more power-related clusters based on a power-related cost function. The instructions also determine an interconnect design for the one or more power-related clusters based on the optimized placement.

### BRIEF DESCRIPTION OF THE FIGURES

FIG. 1 is a schematic diagram of an exemplary functional block that may be switched off by at least one sleep transistor to reduce leakage power consumption in the functional block;

FIG. 2 is a schematic diagram of an exemplary non-optimized interconnect design for a low-power integrated circuit (IC);

FIG. 3 is a schematic diagram of an exemplary optimized interconnect design for reducing the number of sleep transistors relative to those used in the non-optimized interconnect design of FIG. 2 and improving heat dissipation in a low-power IC;

FIG. 4 is a flowchart illustrating an exemplary optimized IC design process for generating the optimized interconnect design of FIG. 3;

FIG. 5A is a plot of an exemplary plurality of simulated annealing (SA) iterations performed by the optimized IC design process of FIG. 4 to generate an optimized two-dimensional (2D) placement design;

FIG. 5B is a plot of an exemplary plurality of SA iterations performed by the optimized IC design process of FIG. 4 to generate an optimized three-dimensional (3D) placement design;

FIG. 6 is a schematic diagram of an exemplary sleep transistor configured to be shared by one or more power-related clusters having positive power correlations;

FIG. 7 is a schematic diagram of an exemplary sleep switch configured to be shared by one or more power-related clusters having negative power correlations;

FIG. 8 is a schematic diagram of an exemplary computer system comprising one or more non-transitory computer readable mediums for storing software instructions to perform the optimized IC design process of FIG. 4; and

FIG. 9 illustrates an example of a processor-based system that can employ an IC fabricated based on the optimized interconnect design of FIG. 3 created by the optimized IC design process of FIG. 4.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include optimizing interconnect designs in low-power integrated circuits (ICs). In this regard, in one aspect, functional blocks having substantially correlated power utilization patterns are grouped into a power-related cluster to share a sleeping cell, thus leading to a reduced number of sleep transistors and a simplified interconnect design in a low-power IC. In another aspect, functional blocks having higher block temperatures are separated into more than one power-related cluster to improve heat dissipation in the low-power IC. A simulated annealing (SA) process is employed to determine an optimized placement for the low-power IC. The SA process utilizes a power-related cost function that includes a power-related parameter and a heat-related parameter, among other parameters, to group the substantially power-correlated functional blocks and to separate the high-temperature functional blocks. By running the SA process based on the power-related cost function, it is possible to determine the optimized placement that leads to the reduced number of sleep transistors and improved heat dissipation in the low-power IC.

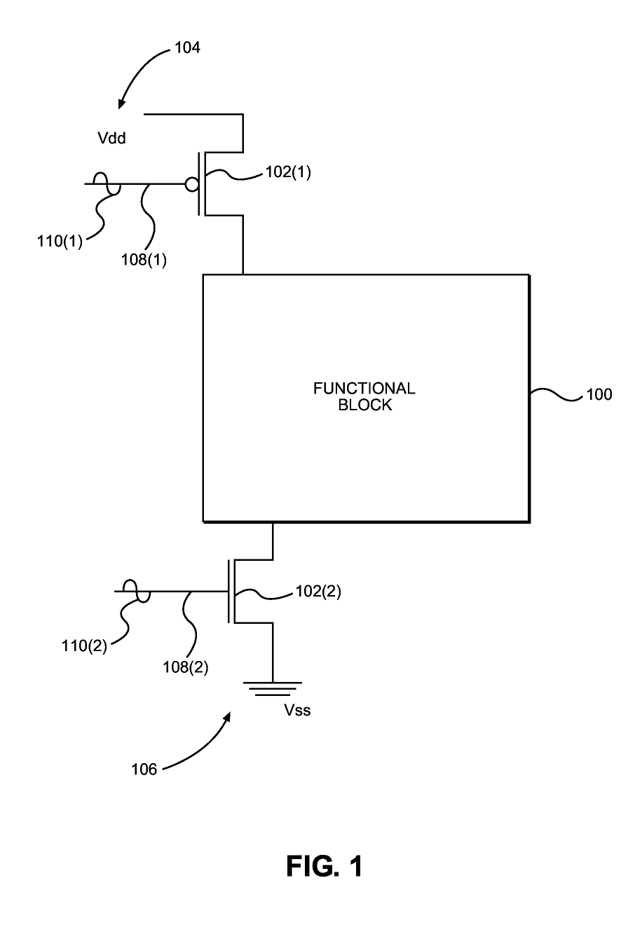

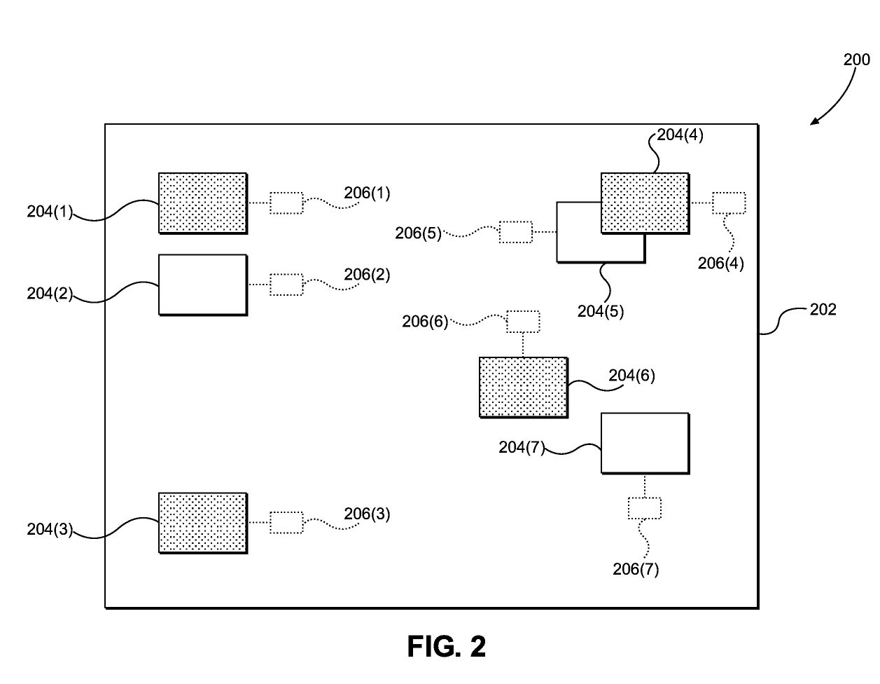

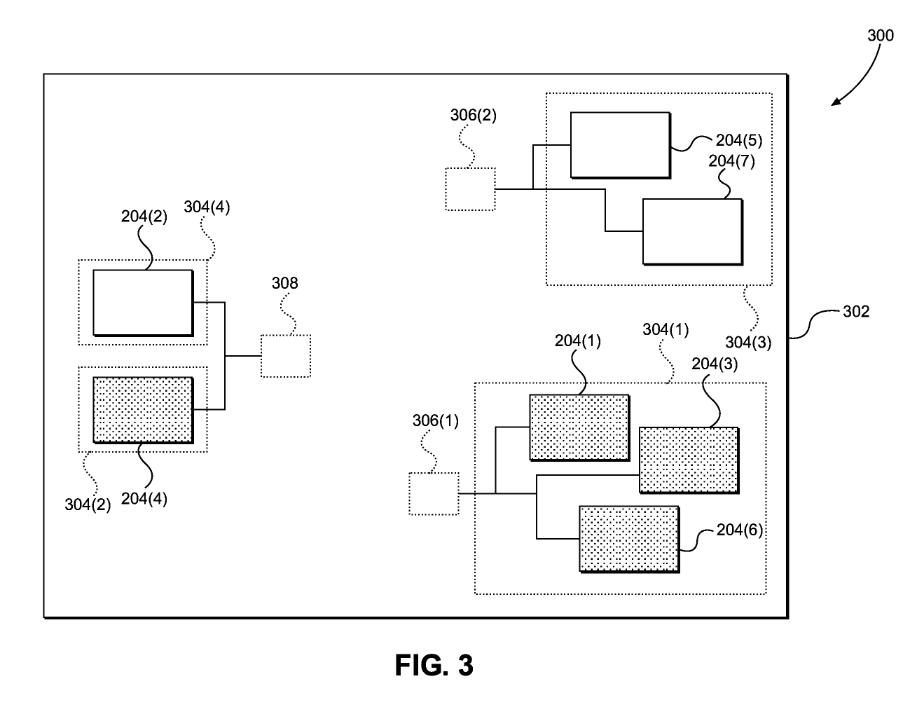

Before discussing aspects of optimizing interconnect designs in low-power ICs that include specific aspects of the present disclosure, an exemplary illustration of a non-optimized IC interconnect design is provided with reference to FIGS. 1 and 2 to provide context for exemplary aspects of the present disclosure and thereby illustrate benefits of exemplary aspects of the present disclosure. The discussion of specific exemplary aspects of optimizing interconnect designs in low-power ICs begins below with reference to FIG. 3.

In this regard, FIG. 1 is a schematic diagram of an exemplary functional block 100 that may be switched off by at least one of sleep transistors 102(1) and 102(2) to reduce leakage power consumption in the functional block 100. In a non-limiting example, the sleep transistor 102(1) may be a p-type metal-oxide semiconductor field-effect transistor (MOSFET) (pMOSFET) sleep transistor and the sleep transistor 102(2) may be an n-type MOSFET (nMOSFET) sleep transistor. The functional block 100 may be switched on or off by the sleep transistor 102(1) or the sleep transistor 102(2). The sleep transistor 102(1) is configured to switch on the functional block 100 by coupling a V_{DD} voltage 104 to the functional block 100. The sleep transistor 102(1) is also configured to switch off the functional block 100 by decoupling the V_{DD} voltage 104 from the functional block 100. In this regard, the sleep transistor 102(1) is often referred to as a header switch to the functional block 100. The sleep transistor 102(2) is configured to switch on the functional block 100 by coupling a V_{SS} voltage 106 to the functional block 100. The sleep transistor 102(2) is also configured to switch off the functional block 100 by decoupling the V_{SS} voltage 106 from the functional block 100. In this regard, the sleep transistor 102(2) is often referred to as a floor switch to the functional block 100.

With continuing reference to FIG. 1, a gate electrode 108(1) of the sleep transistor 102(1) is controlled by a header switch control signal 110(1) to couple the V_{DD} voltage 104 to the functional block 100 or decouple the V_{DD} voltage 104 from the functional block 100. Likewise, a gate electrode 108(2) of the sleep transistor 102(2) is controlled by a floor switch control signal 110(2) to either couple the V_{SS} voltage 106 to the functional block 100 or decouple the V_{SS} voltage 106 from the functional block 100. In this regard, the functional block 100 may be opportunistically switched off by the sleep transistor 102(1) or the sleep transistor 102(2) to reduce leakage power consumption when the functional block 100 is idle or on standby.

FIG. 2 is a schematic diagram of an exemplary non-optimized interconnect design 200 for a low-power IC 202. The low-power IC 202 comprises a plurality of functional blocks 204(1)-204(M), wherein M is a finite positive integer and 204(M) is not shown. For the purpose of illustration, only functional blocks 204(1)-204(7) are discussed hereinafter in the present disclose as non-limiting examples. Understandably, the principles and configurations discussed therein with reference to the functional blocks 204(1)-204(7) are applicable to the plurality of functional blocks 204(1)-204(M).

With continuing reference to FIG. 2, among the functional blocks 204(1)-204(7), the functional blocks 204(1), 204(3), 204(4), and 204(6) are positively correlated with respect to power utilization patterns. In this regard, the functional blocks 204(1), 204(3), 204(4), and 204(6) are configured either to function simultaneously or to be idle simultaneously. The functional blocks 204(2), 204(5), and 204(7) are also positively correlated with respect to the power utilization patterns. However, the functional blocks 204(2), 204(5), and 204(7) are negatively correlated to the functional blocks 204(1), 204(3), 204(4), and 204(6) with regard to the power utilization patterns. In this regard, the functional blocks 204(2), 204(5), and 204(7) will be functional when the functional blocks 204(1), 204(3), 204(4), and 204(6) are idle Likewise, the functional blocks 204(2), 204(5), and 204(7) will be idle when the functional blocks 204(1), 204(3), 204(4), and 204(6) are functional. As is further discussed with regard to FIG. 3, the positive correlation with respect to the power utilization patterns may be explored to help reduce the number of sleep transistors 206(1)-206(7) in the low-power IC 202.

With continuing reference to FIG. 2, the functional blocks 204(1)-204(7) are scattered across the low-power IC 202 under the non-optimized interconnect design 200. As a result, the functional blocks 204(1)-204(7) may have to be individually controlled by the sleep transistors 206(1)-206(7), respectively, to reduce leakage power consumption in the low-power IC 202. The sleep transistors 206(1)-206(7) may be provided as header transistors or floor transistors as previously described in FIG. 1. Understandably, adding the sleep transistors 206(1)-206(7) individually for each of the respective functional blocks 204(1)-204(7) may lead to an increased build of material (BoM) cost for the low-power IC 202. Furthermore, the sleep transistors 206(1)-206(7) may also contribute to leakage power consumption in the low-power IC 202. It is thus desirable to reduce the number of the sleep transistors 206(1)-206(7) in the low-power IC 202 while still being able to reduce leakage power consumption of the functional blocks 204(1)-204(7).

In this regard, FIG. 3 is a schematic diagram of an exemplary optimized interconnect design 300 for reducing the number of sleep transistors relative to those used in the non-optimized interconnect design 200 of FIG. 2 and improving heat dissipation in a low-power IC 302. Elements of FIG. 2 are referenced in connection with FIG. 3 and will not be re-described herein.

As previously discussed in FIG. 2, the functional blocks 204(1), 204(3), 204(4), and 204(6) are positively correlated with respect to power utilization patterns (sometimes referred to herein as power-correlated functional blocks 204). As such, the functional blocks 204(1), 204(3), and 204(6) may be grouped into a power-related cluster 304(1), which is controlled by a sleep transistor 306(1). In this regard, the functional blocks 204(1), 204(3), and 204(6) are switched on simultaneously or switched off simultaneously by the sleep transistor 306(1). Note that the functional block 204(4) is excluded from the power-related cluster 304(1) despite having a positive correlation with the functional blocks 204(1), 204(3), and 204(6) with respect to the power utilization patterns. In a non-limiting example, the functional block 204(4) may have a higher block temperature (sometimes referred to herein as high-temperature functional block) compared to the functional blocks 204(1), 204(3), and 204(6). Therefore, the functional block 204(4) is placed in a power-related cluster 304(2) and disposed apart from the power-related cluster 304(1) to provide better heat dissipation in the low-power IC 302. Likewise, the functional blocks 204(5) and 204(7) are also power-correlated functional blocks that can be grouped into a power-related cluster 304(3) to be controlled by a sleep transistor 306(2). The functional block 204(2) is also a high-temperature functional block, and thus is placed in a power-related cluster 304(4) separated from the power-related cluster 304(3) to improve heat dissipation in the low-power IC 302.

With continuing reference to FIG. 3, as previously described in FIG. 2, the functional blocks 204(2) and 204(4) are negatively correlated with respect to the power utilization patterns. As a result, the functional blocks 204(2) and 204(4) may be configured to share a sleep switch 308. In this regard, the sleep switch 308 is configured to switch on the functional block 204(2) and switch off the functional block 204(4) simultaneously or to switch off the functional block 204(2) and switch on the functional block 204(4) simultaneously. Hence, by grouping the functional blocks 204(1)-204(7) into one or more of the power-related clusters 304(1)-304(4), a reduced number of the sleep transistors 306(1)-306(2) is used in the low-power IC 302. The sleep transistors 306(1)-306(2) may be provided as header transistors or floor transistors as previously described in FIG. 1. Furthermore, by separating the power-related clusters 304(2) and 304(4) from the power-related clusters 304(1) and 304(3), respectively, it is possible to provide improved heat dissipation in the low-power IC 302.

As illustrated in the optimized interconnect design 300 of FIG. 3, the power-correlated functional blocks 204(1), 204(3), and 204(6) are grouped into the power-related cluster 304(1). Likewise, the power-correlated functional blocks 204(5) and 204(7) are grouped into the power-related cluster 304(3). As a result, the low-power IC 302 requires a reduced number of the sleep transistors 306(1)-306(2) and has improved heat dissipation.

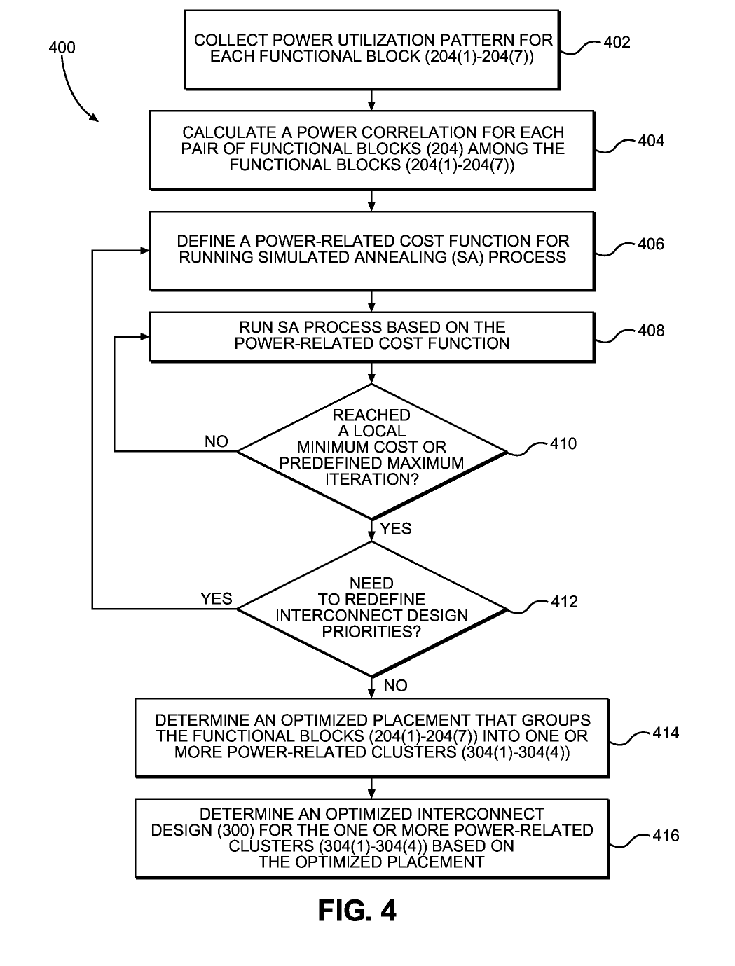

In this regard, FIG. 4 is a flowchart illustrating an exemplary optimized IC design process 400 for generating the optimized interconnect design 300 of FIG. 3. Elements of FIG. 3 are referenced in connection with FIG. 4 and will not be re-described herein.

With continuing reference to FIG. 4, to be able to determine one or more power correlations with respect to the power utilization patterns for the functional blocks 204(1)-204(7), the optimized IC design process 400 collects a power utilization pattern for each of the functional blocks 204(1)-204(7) (block 402). In a non-limiting example, the power utilization pattern for each of the functional blocks 204(1)-204(7) may be collected by running one or more benchmark processes. In another non-limiting example, the power utilization pattern for each of the functional blocks 204(1)-204(7) is collected at N time intervals t₁, t₂, . . . , t_{N}, wherein N is a finite positive integer. In this regard, Table 1 below is an exemplary summary of the power utilization patterns related to each of the functional blocks 204(1)-204(7).

TABLE 1

| | t₁ | t₂ | t₃ | . . . | t_{N} |
|---|---|---|---|---|---|
| 204(1) | p₁₁ | p₁₂ | p₁₃ | | p_{1N} |
| 204(2) | p₂₁ | p₂₂ | p₂₃ | | p_{2N} |
| . | | | | | |
| . | | | | | |
| . | | | | | |
| 204(7) | p₇₁ | p₇₂ | p₇₃ | | p_{7N} |

With reference to Table 1, p₁₁ represents a power utilization of the functional block 204(1) at the time interval t₁, p₁₂ represents a power utilization of the functional block 204(1) at the time interval t₂, and so on. Collectively, the power utilizations p₁₁, p₁₂, . . . , p_{1N} represent the power utilization patterns of the functional block 204(1) at time intervals t₁, t₂, . . . , t_{N}, respectively.

With continuing reference to FIG. 4, the optimized IC design process 400 calculates a power correlation for each pair of functional blocks among the functional blocks 204(1)-204(7) based on the power utilization patterns collected in Table 1 (block 404). Although it is theoretically possible to calculate the power correlation manually, it may be desirable to perform the calculation using a computing device. In a non-limiting example, for a given pair of functional blocks 204(i) (first functional block) and 204(j) (second functional block), wherein i and j are less than or equal to M (i.e., the number of functional blocks 204) in Table 1, the power correlation ρ(i,j) may be calculated based on the equation (Eq. 1) below:

$$ρ ( i , j ) = \frac{cov ( i , j )}{{σ}_{i} \cdot {σ}_{j}} \qquad ( Eq . 1 )$$

Wherein cov(i,j) in Eq. 1 is a covariant matrix between the functional blocks 204(i) and 204(j). The covariant matrix can be calculated based on the equation (Eq. 2) below:

$$cov ( i , j ) = {\sum }_{τ = 1}^{𝒩} {p}_{τ i} \cdot {p}_{τ j} - \frac{1}{N} {\sum }_{τ = 1}^{𝒩} {p}_{τ i} {\sum }_{τ = 1}^{𝒩} {p}_{τ j} \qquad ( Eq . 2 )$$

Wherein σᵢ (first standard deviation) and σⱼ (second standard deviation) in Eq. 1 are standard deviations of the functional blocks 204(i) and 204(j), respectively. The standard deviations σᵢ and σⱼ are calculated based on the equations (Eq. 3 and Eq. 4) below:

$$\begin{matrix}{σ}_{i} = \sqrt{{\sum }_{τ = 1}^{𝒩} \frac{{p}_{τ i}^{2}}{𝒩} - {( {\sum }_{τ = 1}^{𝒩} \frac{{p}_{τ i}}{𝒩} )}^{2}} & ( Eq . 3 ) \\ {σ}_{j} = \sqrt{{\sum }_{τ = 1}^{𝒩} \frac{{p}_{τ j}^{2}}{𝒩} - {( {\sum }_{τ = 1}^{𝒩} \frac{{p}_{τ j}}{𝒩} )}^{2} {( {\sum }_{τ = 1}^{𝒩} \frac{{p}_{τ j}}{𝒩} )}^{2}} & ( Eq . 4 )\end{matrix}$$

With continuing reference to FIG. 4, the optimized IC design process 400 groups the plurality of functional blocks 204(1)-204(M) into one or more of the power-related clusters 304(1)-304(4) and, subsequently, generates an optimized placement for the one or more of the power-related clusters 304(1)-304(4) by running an SA process. The SA process is a generic probabilistic metaheuristic for a global optimization problem with a given cost function by finding a good approximation of global optimum. The SA process starts at an initial state with an initial cost value. The SA process then randomly chooses a next step in which to move. For each step, the SA process considers the cost of a current state S and a possible next state S′. A change of state happens when the cost corresponding to the next state S′ is lower than the current state S. Alternatively, the SA process may move from the current state S to the next state S′ regardless of the cost with a certain probability which depends on the cost of the next state S′ and the current state S. Meanwhile, this probability will decay as the SA process progresses. This mechanism ensures the whole SA process will reach a stable, local minimum state at the end of the SA process. When the SA process is employed to generate the optimized placement for the one or more of the power-related clusters 304(1)-304(4), the acceptance probability associated with moving from the current state S to the next state S′ depends on the costs of the current state S and the next state S′ and block temperature T of the functional blocks 204(1)-204(7). The block temperature T will decay as the SA process goes through multiple iterations over time. At the end of the SA process, the block temperature T becomes too low to warrant a move from the current state S to the next state S′ without increasing the cost or reducing the acceptance probability. At this point, the SA process has reached a local minimum cost, whereby the optimized placement for the functional blocks 204(1)-204(7) is determined. In some cases, the SA process may not be able to reach the local minimum cost. To prevent an endless loop of the SA process, it is possible to stop the SA process after reaching a predetermined maximum number of iterations.

With continuing reference to FIG. 4, the optimized IC design process 400 then defines a power-related cost function for running the SA process (block 406). In a non-limiting example, the power-related cost function, which is defined by the equation (Eq. 5) below, provides a plurality of simulation input parameters for the SA process:

C=α·Wire+β·Area+γ·Power+μ·Heat (Eq. 5)

With reference to Eq. 5, the Wire parameter is a wire-related parameter dictating a wire-length distance among the functional blocks 204(1)-204(7), and α is a wire-related weight factor. The Area parameter is an area-related parameter dictating physical dimensions of the low-power IC 302, and β is an area-related weight factor. The Power parameter is a power-related parameter configured to provide a power-correlation constraint to the power-related cost function, and γ is a power-related weight factor. The Heat parameter is a heat-related parameter configured to provide a temperature constraint to the power-related cost function, and μ is a heat-related weight factor. In a non-limiting example, a summation of the wire-related weight factor α, the area-related weight factor β, the power-related weight factor γ, and the heat-related weight factor μ equals one (1). In this regard, the wire-related weight factor α, the area-related weight factor β, the power-related weight factor γ, or the heat-related weight factor μ may be adjusted to change the emphasis of the power-related cost function.

With continuing reference to Eq. 5, the Power parameter may be calculated based on the equation (Eq. 6) below:

Power=Σ(ρᵢⱼ·Adjᵢⱼ) (Eq. 6)

Wherein ρ(i,j) is the power correlation between the functional block 204(i) and the functional block 204(j). Adjᵢⱼ is a Boolean parameter, which is set to zero (0) when the functional blocks 204(i) and 204(j) are adjacent, and is set to one (1) when the functional blocks 204(i) and 204(j) are apart. The Heat parameter in Eq. 5 may be calculated based on the equation (Eq. 7) below:

Heat=Σ(ρᵢⱼ·dᵢⱼ·sᵢ·sⱼ) (Eq. 7)

Wherein dᵢⱼ is a geometric distance between the functional blocks 204(i) and 204(j). Parameters sᵢ and sⱼ represent the thermal coefficients of the functional blocks 204(i) and 204(j), respectively.

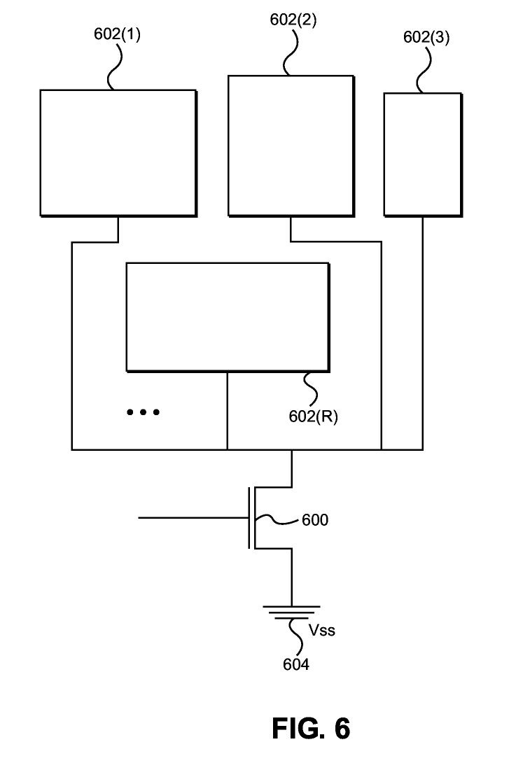

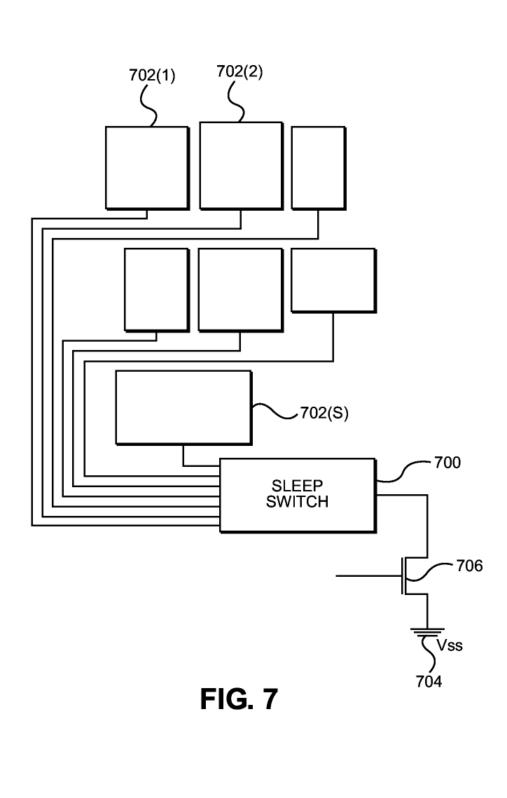

With reference back to FIG. 4, after defining the power-related cost function according to equations 5, 6, and 7, the optimized IC design process 400 executes the SA process based on the power-related cost function (block 408). The SA process groups the plurality of functional blocks 204(1)-204(M) into one or more of the power-related clusters 304(1)-304(4) and, subsequently, generates an optimized placement for the one or more of the power-related clusters 304(1)-304(4). The SA process may go through multiple iterations of block 408 if the SA process does not reach the local minimum cost or the predefined maximum iteration (block 410). At this point, the wire-related weight factor α, the area-related weight factor β, the power-related weight factor γ, or the heat-related weight factor μ may be adjusted to change the emphasis of the power-related cost function (block 412) and the SA process may be repeated. Otherwise, the optimized IC design process 400 is able to determine an optimized placement that groups the functional blocks 204(1)-204(7) into the one or more of the power-related clusters 304(1)-304(4) (block 414). Finally, it is possible to determine the optimized interconnect design 300 of FIG. 3 for the one or more of the power-related clusters 304(1)-304(4) based on the optimized placement (block 416). As described in FIGS. 6 and 7 below, determination of the optimized interconnect design 300 also includes determining the placements of the sleep transistors 306(1) and 306(2) and the sleep switch 308 in the low-power IC 302 based on the optimized placement.

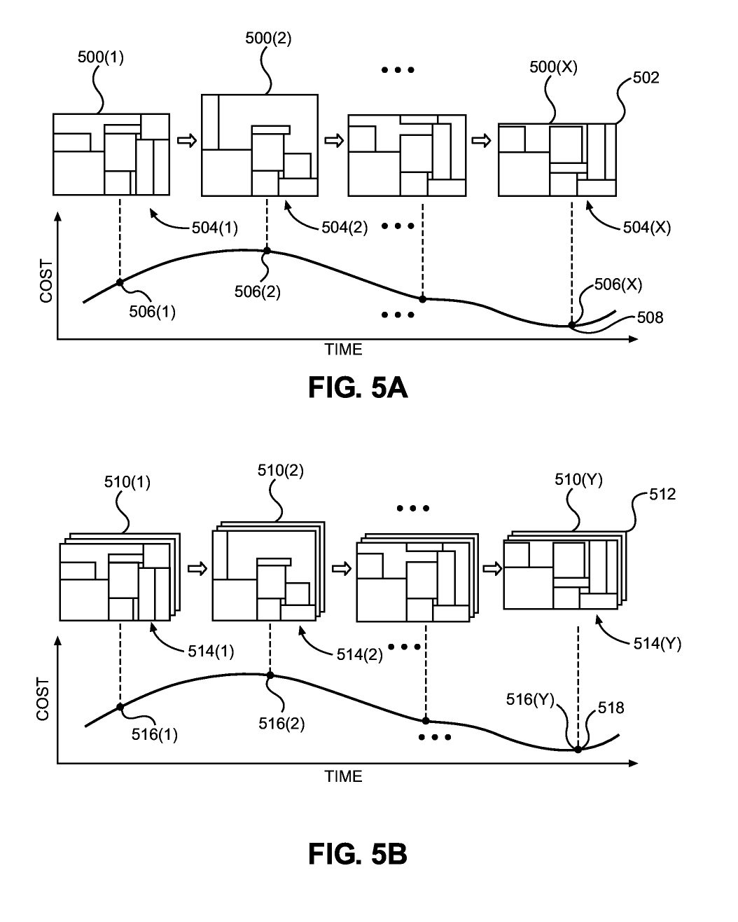

As discussed above, the SA process may go through multiple iterations until reaching the local minimum cost or the predefined maximum iteration. In this regard, FIG. 5A is a plot of an exemplary plurality of SA iterations 500(1)-500(X) performed by the optimized IC design process 400 of FIG. 4 to generate an optimized two-dimensional (2D) placement design 502. Elements of FIG. 4 are referenced in connection with FIG. 5A and will not be re-described herein.

With continuing reference to FIG. 5A, the plurality of SA iterations 500(1)-500(X) correspond to a plurality of 2D placement designs 504(1)-504(X) and a plurality of costs 506(1)-506(X), respectively. The SA process starts with 2D placement design 504(1) (initial 2D placement) that corresponds to cost 506(1) (initial cost). During each of the plurality of SA iterations 500(1)-500(X), the SA process evaluates one or more possible 2D placement designs (not shown) that correspond to one or more possible costs (not shown) to determine the next 2D placement design 504(P) (1<P≦X) in which to move, wherein 504(P) refers to any 2D placement design among the plurality of 2D placement designs 504(1)-504(X). In this regard, the SA process progresses through the plurality of 2D placement designs 504(1)-504(X) and eventually arrives at the optimized 2D placement design 502 that corresponds to an optimized cost 508.

The optimized IC design process 400 of FIG. 4 may also be employed to generate an optimized three-dimensional (3D) placement design. In this regard, FIG. 5B is a plot of an exemplary plurality of SA iterations 510(1)-510(Y) performed by the optimized IC design process 400 of FIG. 4 to generate an optimized 3D placement design 512.

With continuing reference to FIG. 5B, the plurality of SA iterations 510(1)-510(Y) correspond to a plurality of 3D placement designs 514(1)-514(Y) and a plurality of costs 516(1)-516(Y), respectively. The SA process starts with 3D placement design 514(1) (initial 3D placement) that corresponds to cost 516(1) (initial cost). During each of the plurality of SA iterations 510(1)-510(Y), the SA process evaluates one or more possible 3D placement designs (not shown) that correspond to one or more possible costs (not shown) to determine the next 3D placement design 514(Q) (1<Q≦Y) in which to move, wherein 514(Q) refers to any 3D placement design among the plurality of 3D placement designs 514(1)-514(Y). In this regard, the SA process progresses through the plurality of 3D placement designs 514(1)-514(Y) and eventually arrives at the optimized 3D placement design 512 that corresponds to an optimized cost 518.

As previously discussed in FIG. 4, the determination of the optimized interconnect design 300 of FIG. 3 includes determining the placements of the sleep transistors 306(1) and 306(2) and the sleep switch 308 in the low-power IC 302 based on the optimized placement generated by the optimized IC design process 400 in FIG. 4. In this regard, FIGS. 6 and 7 are directed to sleep transistor and sleep switch placements, respectively.

FIG. 6 is a schematic diagram of an exemplary sleep transistor 600 configured to be shared by one or more power-related clusters 602(1)-602(R) having positive power correlations. With regard to FIG. 6, the one or more power-related clusters 602(1)-602(R) are said to have positive power correlations because the one or more power-related clusters 602(1)-602(R) are configured to be functional simultaneously or idle simultaneously. As a result, the one or more power-related clusters 602(1)-602(R) can be configured to share the sleep transistor 600, thus reducing the number of sleep transistors used in the low-power IC 302 of FIG. 3. As illustrated in FIG. 6, as a non-limiting example, the sleep transistor 600 is configured to couple a V_{SS} voltage 604 to the one or more power-related clusters 602(1)-602(R) or decouple the V_{SS} voltage 604 from the one or more power-related clusters 602(1)-602(R). In this regard, the sleep transistor 600 is an nMOSFET and is provided as a floor transistor. In another non-limiting example, the sleep transistor 600 may also be a pMOSFET, and thus be provided as a header transistor.

FIG. 7 is a schematic diagram of an exemplary sleep switch 700 configured to be shared by one or more power-related clusters 702(1)-702(S) having negative power correlations. With regard to FIG. 7, the one or more power-related clusters 702(1)-702(S) are said to have negative power correlations because the one or more power-related clusters 702(1)-702(S) are not configured to be functional simultaneously. As a result, the one or more power-related clusters 702(1)-702(S) can be configured to share the sleep switch 700, thus reducing overall temperature of the low-power IC 302 of FIG. 3. As illustrated in FIG. 7, as a non-limiting example, the sleep switch 700 is coupled to a V_{SS} voltage 704 through a sleep transistor 706. The sleep transistor 706 is configured to couple the V_{SS} voltage 704 to the sleep switch 700. By using the sleep switch 700 to alternately couple the one or more power-related clusters 702(1)-702(S) to the V_{SS} voltage 704, the overall temperature of the low-power IC 302 of FIG. 3 is reduced.

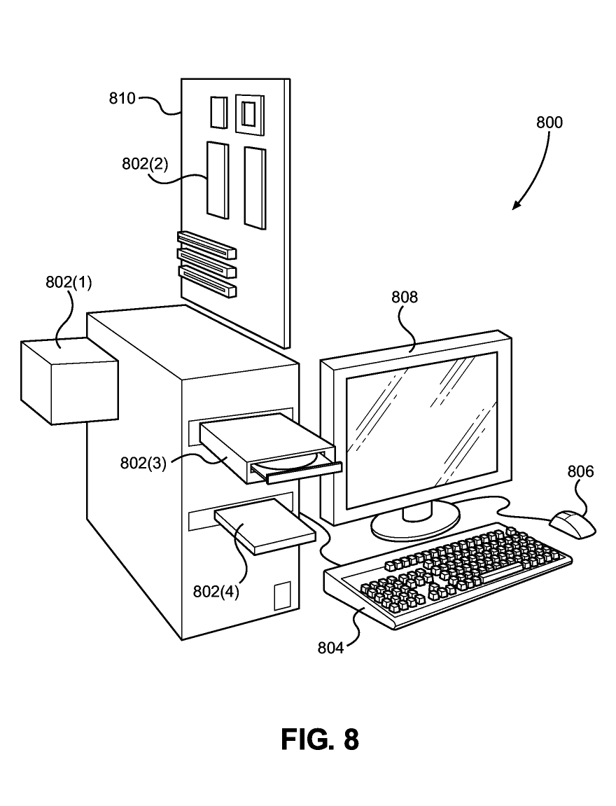

The optimized IC design process 400 of FIG. 4 may be performed based on software instructions stored in a non-transitory computer readable medium. In this regard, FIG. 8 is a schematic diagram of an exemplary computer system 800 comprising one or more non-transitory computer readable mediums 802(1)-802(4) for storing software instructions to perform the optimized IC design process 400 of FIG. 4.

With continuing reference to FIG. 8, the one or more non-transitory computer readable mediums 802(1)-802(4) further comprise a hard drive 802(1), an on-board memory system 802(2), a compact disc 802(3), and a floppy disk 802(4). Each of the one or more non-transitory computer readable mediums 802(1)-802(4) may be configured to store the software instructions to perform the optimized IC design process 400 of FIG. 4. The computer system 800 also comprises a keyboard 804 and a computer mouse 806 for inputting the software instructions onto the one or more non-transitory computer readable mediums 802(1)-802(4) for use by the software instructions on the computer readable mediums 802(1)-802(4). The computer system 800 also comprises a monitor 808 for outputting results of the optimized IC design process 400 of FIG. 4. Further, the computer system 800 comprises a processor 810 configured to read the software instructions from the one or more non-transitory computer readable mediums 802(1)-802(4) and execute the software instructions to perform the optimized IC design process 400. While the computer system 800 is illustrated as a single device, the computer system 800 may also comprise a plurality of computer systems 800 that are deployed according to a centralized topology or a distributed topology.

The optimized interconnect design 300 of FIG. 3 created by the optimized IC design process 400 of FIG. 4 may be fabricated into an IC that is provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

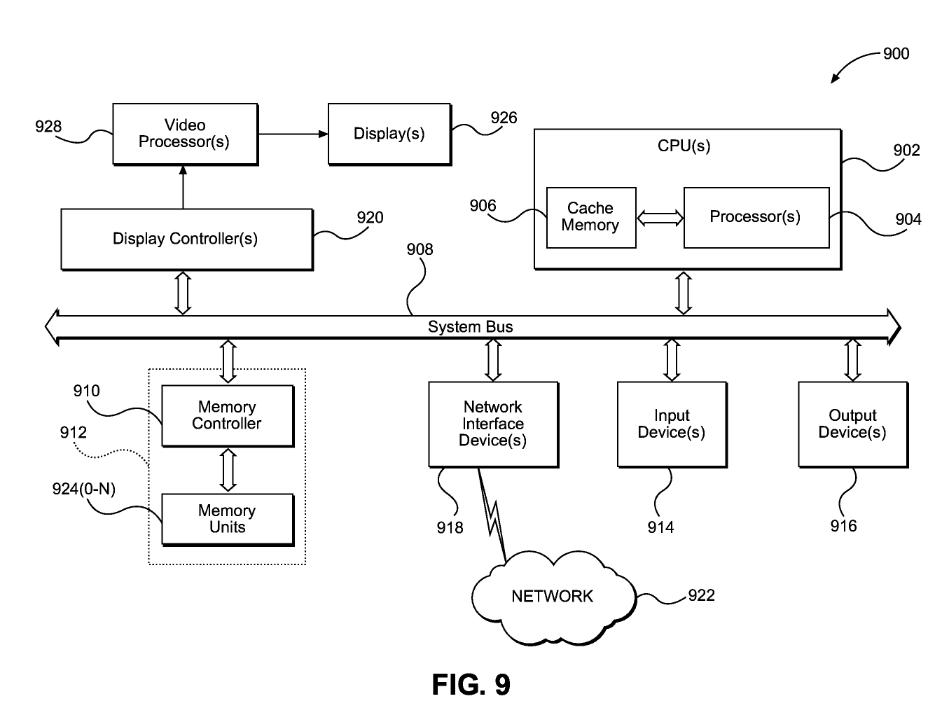

In this regard, FIG. 9 illustrates an example of a processor-based system 900 that can employ the IC fabricated based on the optimized interconnect design 300 of FIG. 3 created by the optimized IC design process 400 of FIG. 4. In this example, the processor-based system 900 includes one or more central processing units (CPUs) 902, each including one or more processors 904. The CPU(s) 902 may have cache memory 906 coupled to the processor(s) 904 for rapid access to temporarily stored data. The CPU(s) 902 is coupled to a system bus 908 and can intercouple master and slave devices included in the processor-based system 900. As is well known, the CPU(s) 902 communicates with these other devices by exchanging address, control, and data information over the system bus 908. For example, the CPU(s) 902 can communicate bus transaction requests to a memory controller 910 as an example of a slave device. Although not illustrated in FIG. 9, multiple system buses 908 could be provided, wherein each system bus 908 constitutes a different fabric.

Other master and slave devices can be connected to the system bus 908. As illustrated in FIG. 9, these devices can include a memory system 912, one or more input devices 914, one or more output devices 916, one or more network interface devices 918, and one or more display controllers 920, as examples. The input device(s) 914 can include any type of input device, including, but not limited to, input keys, switches, voice processors, etc. The output device(s) 916 can include any type of output device, including, but not limited to, audio, video, other visual indicators, etc. The network interface device(s) 918 can be any device configured to allow exchange of data to and from a network 922. The network 922 can be any type of network, including, but not limited to, a wired or wireless network, a private or public network, a local area network (LAN), a wireless local area network (WLAN), a Bluetooth™ network, a wide area network (WAN), a BLUETOOTH™ network, or the Internet. The network interface device(s) 918 can be configured to support any type of communications protocol desired. The memory system 912 can include one or more memory units 924(0-N).

The CPU(s) 902 may also be configured to access the display controller(s) 920 over the system bus 908 to control information sent to one or more displays 926. The display controller(s) 920 sends information to the display(s) 926 to be displayed via one or more video processors 928, which process the information to be displayed into a format suitable for the display(s) 926. The display(s) 926 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master devices and slave devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagram may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for designing an optimized interconnect design in a low-power integrated circuit (IC), comprising:
determining, using software on a computing device, one or more power correlations for a plurality of functional blocks in a low-power IC;
grouping the plurality of functional blocks into one or more power-related clusters based on the one or more power correlations for the plurality of functional blocks;
generating, using the software on the computing device, an optimized placement for the one or more power-related clusters based on a power-related cost function;
determining an interconnect design for the one or more power-related clusters based on the optimized placement; and
outputting a finalized interconnect design through an output device associated with the computing device.

2. The method of claim 1, further comprising
collecting one or more power utilization patterns for each of the plurality of functional blocks; and
calculating a power correlation using the computing device for each pair of functional blocks among the plurality of functional blocks, comprising:
calculating a covariant matrix for the pair of functional blocks based on respective power utilization patterns of a first functional block and respective power utilization patterns of a second functional block among the pair of functional blocks;
calculating a first standard deviation and a second standard deviation for the first functional block and the second functional block, respectively; and
dividing the covariant matrix by the first standard deviation and the second standard deviation.

3. The method of claim 2, further comprising collecting the one or more power utilization patterns for the each of the plurality of functional blocks through running one or more benchmark processes running on the computing device.

4. The method of claim 2, wherein the power correlation for the each pair of functional blocks among the plurality of functional blocks is greater than or equal to negative one (−1) and less than or equal to one (1).

5. The method of claim 1, further comprising grouping the plurality of functional blocks and generating the optimized placement by running a simulated annealing (SA) process based on the power-related cost function and a plurality of simulation input parameters, wherein the power-related cost function comprises:
a wire-related parameter associated with a wire-related weight factor;
an area-related parameter associated with an area-related weight factor;
a power-related parameter associated with a power-related weight factor; and
a heat-related parameter associated with a heat-related weight factor.

6. The method of claim 5, wherein generating the optimized placement further comprises:
defining the wire-related weight factor, the area-related weight factor, the power-related weight factor, and the heat-related weight factor in the power-related cost function;
providing the one or more power correlations of the plurality of functional blocks as the plurality of simulation input parameters for the SA process; and
running the SA process until reaching a local minimum cost relative to the power-related cost function or reaching a predetermined maximum number of iterations.

7. The method of claim 6, wherein the SA process generates the optimized placement when the SA process reaches the local minimum cost relative to the power-related cost function.

8. The method of claim 6, wherein the SA process is configured to group one or more power-correlated functional blocks into a power-related functional cluster.

9. The method of claim 6, wherein the SA process is configured to separate one or more high-temperature functional blocks into more than one power-related clusters.

10. The method of claim 9, wherein the SA process is further configured to place the more than one power-related clusters apart from each other in the low-power IC to improve heat dissipation.

11. The method of claim 6, further comprising:
adjusting the wire-related weight factor, the area-related weight factor, the power-related weight factor, and the heat-related weight factor in the power-related cost function;
providing the one or more power correlations of the plurality of functional blocks as the plurality of simulation input parameters for the SA process; and
rerunning the SA process until reaching the local minimum cost relative to the power-related cost function or reaching the predetermined maximum number of iterations.

12. The method of claim 1, further comprising sharing a sleep transistor between the one or more power-related clusters having positive power correlations.

13. The method of claim 12, wherein the sleep transistor is an n-type metal-oxide semiconductor field-effect transistor (MOSFET) (nMOSFET) or a p-type MOSFET (pMOSFET).

14. The method of claim 1, further comprising sharing a sleep switch between the one or more power-related clusters having negative power correlations.

15. A method for optimizing interconnect design in a low-power integrated circuit (IC), comprising:
determining a power correlation for each pair of functional blocks in a low-power IC;
generating an optimized placement comprising one or more power-related clusters by running a simulated annealing (SA) process using a computing device, wherein:
the SA process is based on a power-related cost function and the power correlation of each pair of functional blocks; and
the SA process stops when reaching a local minimum cost relative to the power-related cost function or reaching a predetermined maximum number of iterations;
determining an interconnect design for the one or more power-related clusters based on the optimized placement, including:
sharing a sleep transistor between the one or more power-related clusters having positive power correlations; and
sharing a sleep switch between the one or more power-related clusters having negative power correlations; and
outputting a finalized interconnect design through an output device associated with the computing device.

16. An integrated circuit (IC) formed by the method of claim 1.

17. A non-transitory computer readable medium comprising software with instructions to:
determine one or more power correlations for a plurality of functional blocks in a low-power integrated circuit (IC);
group the plurality of functional blocks into one or more power-related clusters based on the one or more power correlations;
generate an optimized placement for the one or more power-related clusters based on a power-related cost function; and
determine an interconnect design for the one or more power-related clusters based on the optimized placement.

18. The non-transitory computer readable medium of claim 17, wherein the power-related cost function comprises:
a wire-related parameter associated with a wire-related weight factor;
an area-related parameter associated with an area-related weight factor;
a power-related parameter associated with a power-related weight factor; and
a heat-related parameter associated with a heat-related weight factor.

19. The non-transitory computer readable medium of claim 18, wherein the instructions are further configured to:
execute a simulated annealing (SA) process based on the power-related cost function to generate the optimized placement; and
stop the SA process when reaching a local minimum cost relative to the power-related cost function or reaching a predetermined maximum number of iterations.

20. The non-transitory computer readable medium of claim 17, wherein the instructions are further configured to:
group one or more power-correlated functional blocks into a power-related functional cluster; and
separate one or more high-temperature functional blocks into more than one power-related clusters.
